(19) United States
(12) Patent Application Publication
(10) Pub. No.: US 2014/0042322 A1
(43) Pub. Date: Feb. 13, 2014

(54) Portable System and Method for Detecting Drug Materials

(71) Applicant: ChemImage Corporation, PITTSBURGH, PA (US)

(72) Inventors: Patrick Treado, PITTSBURGH, PA (US); MATTHEW NELSON, HARRISON CITY, PA (US); CHARLES GARDNER, JR., GIBSONIA, PA (US)

(73) Assignee: ChemImage Corporation, PITTSBURGH, PA (US)

(21) Appl. No.: 14/055,554

(22) Filed: Oct. 16, 2013

Related U.S. Application Data
(63) Continuation-in-part of application No. 12/802,649, filed on Jun. 11, 2010.
Application No. 12/802,649 is a continuation-in-part of application No. 13/134,978, filed on Jun. 22, 2011.
Application No. 13/134,978 is a continuation of application No. 13/068,645, filed on May 17, 2011, now Pat. No. 8,052,163.
(60) Provisional application No. 61/714,570, filed on Oct. 16, 2012.

(51) Int. Cl. G01N 21/25

(52) U.S. Cl. CPC G01N 21/25
USPC 250/339.01

(57) ABSTRACT

A portable system and method for detecting drug materials. A portable system may comprise at least one collection lens for collecting a plurality of interacted photons, a tunable filter for filtering the photons, and a SWIR detector for generating at least one SWIR data set representative of a first location comprising an unknown sample. A processor may analyze the SWIR data set to associate the unknown material with a known drug material. A method may comprise collecting a plurality of interacted photons, filtering the interacted photons into a plurality of wavelength bands, detecting the filtered photons to generate a SWIR data set and analyzing the SWIR data set to associate an unknown material with a known drug material.

### RELATED APPLICATIONS

This application claims priority under 35 U.S.C. §119(e) to pending U.S. Provisional Patent Application No. 61/714,570, filed on Oct. 16, 2012, entitled “System and Method for Material Detection Using Short Wave Infrared Hyperspectral Imaging.” This application is also a continuation-in-part to the following pending U.S. patent application Ser. No. 12/802,649, filed on Jun. 11, 2010, entitled “Portable System for Detecting Explosives and a Method for Use Thereof,” Ser. No. 13/134,978, filed on Jun. 22, 2011, entitled “Portable System for Detecting Explosive Materials Using Near Infrared Hyperspectral Imaging and Method for Using Thereof,” Ser. No. 13/068,645, filed on May 12, 2011, entitled “Portable System for Detecting Hazardous Agents Using SWIR and Method for User Thereof” These Applications are hereby incorporated by reference in their entireties.

### BACKGROUND

Spectroscopic imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e. chemical) imaging typically comprise an illumination source, image gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or complementary metal-oxide semiconductor (CMOS) detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the an entire area encompassing the sample simultaneously using an electronically tunable optical imaging filter such as an acousto-optic tunable filter (AOTF) or a liquid crystal tunable filter (LCTF). Here, the organic material in such optical filters is actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image.

Spectroscopic devices operate over a range of wavelengths due to the operation ranges of the detectors or tunable filters possible. This enables analysis in the ultraviolet (UV), visible (VIS), near infrared (NIR), short-wave infrared (SWIR), mid infrared (MIR) wavelengths and to some overlapping ranges. These correspond to wavelengths of about 180-380 nm (UV), about 380-700 nm (VIS), about 700-2500 nm (NIR), about 850-1700 nm (SWIR), 700-1700 (VIS-NIR), about 2500-5000 nm (MIR), and about 5000-25000 nm (LWIR). There exists a need for a system and method for detecting unknown materials such as illicit and non-illicit drugs. It would be advantageous if such a system and method would operate in a portable or handheld configuration.

### SUMMARY

The present disclosure provides for a portable system and method for detecting unknown materials such as illicit and non-illicit drugs. In one embodiment, the present disclosure provides for collecting a plurality of interacted photons from a first location wherein the first location comprises at least one unknown material. The interacted photons may be filtered into a plurality of wavelength bands. These filtered photons may be detected to generate at least one SWIR data set representative of the first location. The SWIR data set may be analyzed to associate the unknown material with at least one known material, wherein the known material comprises at least one drug material.

In another embodiment, the present disclosure provides for a portable system. The portable system may comprise at least one collection lens configured to collect a plurality of interacted photons from a first location, wherein the first location comprises at least one unknown material. The portable device may comprise a tunable filter, configured to filter the plurality of interacted photons into a plurality of wavelength bands. A detector may be configured to detect the filtered photons and generate at least one SWIR data set representative of the first location. At least one processor may be configured to analyze the SWIR data set to associate the unknown material with at least one known material, wherein the known material comprises at least one drug material.

In yet another embodiment, the present disclosure provides for a non-transitory data storage medium containing program code, which, when executed by a processor causes the processor to: collect a plurality of interacted photons from a first location wherein the first location comprises at least one unknown material, filter the interacted photons into a plurality of wavelength bands, detect the filtered photons to generate at least one SWIR data set representative of the first location, and analyze the SWIR data set to associate the unknown material with at least one known material, wherein the known material comprises at least one drug.

### BRIEF DESCRIPTION OF THE DRAWINGS

The accompanying drawings, which are included to provide further understanding of the disclosure and are incorporated in and constitute a part of this specification illustrate embodiments of the disclosure, and together with the description, serve to explain the principles of the disclosure.

In the drawings:

FIG. 1 is representative of a method of the present disclosure.

FIG. 2 is representative of spectra associated with known drug materials.

FIG. 3A is illustrative of an exemplary housing of a portable system of the present disclosure.

FIG. 3B is illustrative of a portable system of the present disclosure.

FIG. 4 is illustrative of a portable system of the present disclosure.

FIGS. 5A-5C are illustrative of the detection capabilities of a portable system and method of the present disclosure.

FIG. 6 is illustrative of the detection capabilities of a portable system and method of the preset disclosure.

FIG. 7 is illustrative of the detection capabilities of a portable system and method of the preset disclosure.

FIG. 8 is illustrative of the detection capabilities of SWIR technology.

FIG. 9 is illustrative of the detection capabilities of SWIR technology.

FIG. 10 is illustrative of the detection capabilities of SWIR technology.

FIG. 11 is illustrative of the detection capabilities of SWIR technology.

FIG. 12 is illustrative of the detection capabilities of SWIR technology.

FIG. 13 is illustrative of the detection capabilities of SWIR technology.

FIG. 14 is illustrative of the detection capabilities of SWIR technology.

FIG. 15 is illustrative of the detection capabilities of SWIR technology.

FIG. 16 is illustrative of the detection capabilities of SWIR technology.

FIG. 17 is illustrative of the detection capabilities of SWIR technology.

FIG. 18 is illustrative of the detection capabilities of SWIR technology.

FIG. 19 is illustrative of the detection capabilities of SWIR technology.

FIG. 20 is illustrative of the detection capabilities of SWIR technology.

FIG. 21 is illustrative of the detection capabilities of SWIR technology and partial least squares discriminant analysis (PLSDA).

FIG. 22 is illustrative of the detection capabilities of SWIR technology and Mahalanobis Distance (MD) analysis.

### DETAILED DESCRIPTION

Reference will now be made in detail to the embodiments of the present disclosure, examples of which are illustrated in the accompanying drawings. Wherever possible, the same reference numbers will be used throughout the specification to refer to the same or like parts.

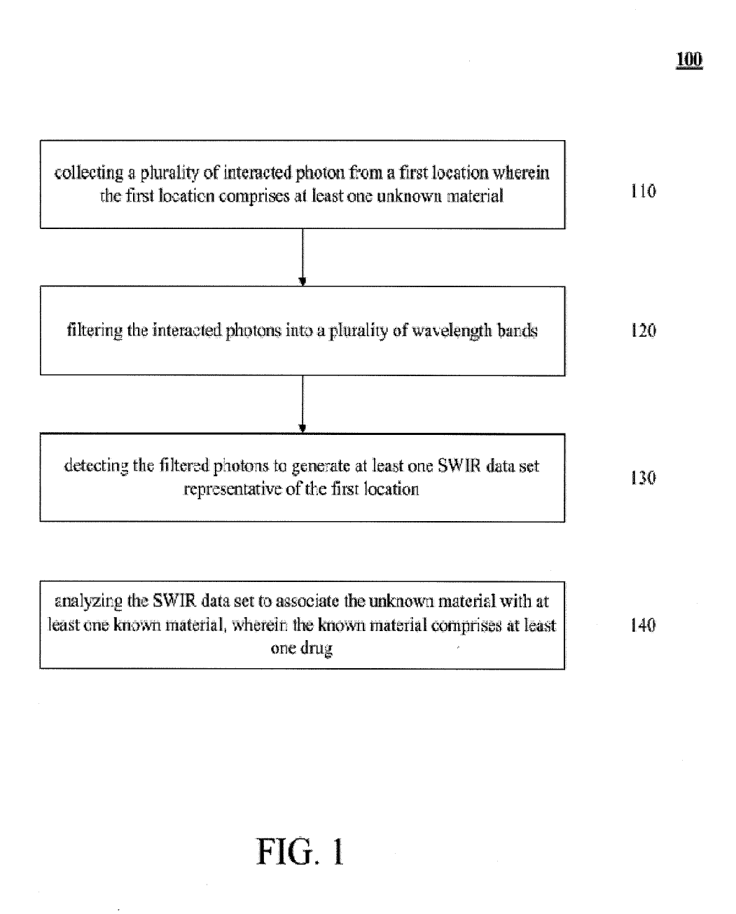

The present disclosure provides for a method for detecting drug materials, one embodiment of which is illustrated by FIG. 1. As used herein, “drugs,” “drugs,” or “drug material,” may refer to either illicit and/or non-illicit drugs. The method 100 may comprise collecting a plurality of interacted photons from a first location in step 110. The interacted photons may comprise at least one of: photons scattered by the sample, photons absorbed by the sample, photons reflected by the sample, and photons emitted by the sample. The first location may comprise at least one unknown material. In one embodiment, the interacted photons may be generated using at least one of passive illumination and active illumination. In an embodiment using active illumination, the present disclosure contemplates illuminating photons may be used to illuminate the first location, wherein the illuminating photons emanate from the same portable device used to detect filtered photons.

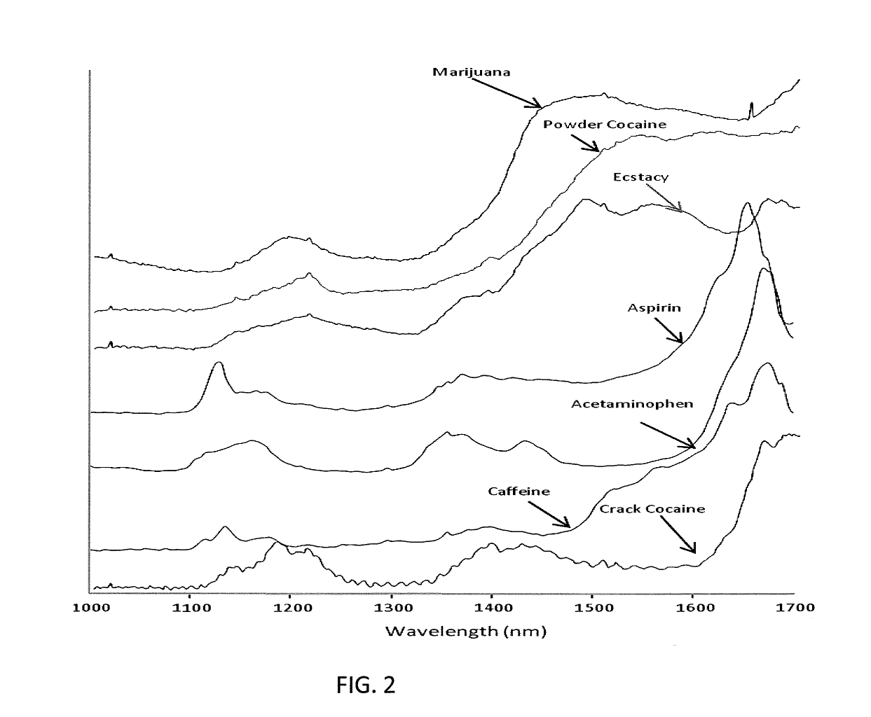

In step 120, the interacted photons may be filtered into a plurality of wavelength bands. These filtered photons may be detected in step 130 to generate at least one SWIR data set representative of the first location. In one embodiment, the SWIR data set may comprise at least one of: a SWIR spectrum and a SWIR hyperspectral image. The SWIR data set may be analyzed in step 140 to associate the unknown material with at least one known material, wherein the known material comprises at least one drug. The SWIR data set may be analyzed by applying one or more algorithms. In one embodiment, the algorithm may be applied to compare the SWIR data set with at least one reference data set, wherein each reference data set is associated with a known drug material. For example, FIG. 2 is representative of reference spectra associated with known drug materials. Reference spectra such as that illustrated may be used to analyzing the SWIR data set.

In one embodiment, the algorithm may comprise at least one ratiometric techniques, such as wavelength division. In another embodiment, the algorithm may comprise at least one chemometric technique. Examples of chemometric techniques include, but are not limited to: principle component analysis (PCA), PLSDA, cosine correlation analysis (CCA), Euclidian distance analysis (EDA), k-means clustering, multivariate curve resolution (MCR), band t. entropy method (BTEM), MD, adaptive subspace detector (ASD), spectral mixture resolution, and combinations thereof. Others, known in the art, may also be applied.

In one embodiment, the method 100 may further comprise selecting the first location by analyzing at least one RGB image representative of a region of interest. In such an embodiment, the same portable device used to generate the SWIR data set may be used to generate at least one RGB image of a region of interest. This RGB image may be analyzed to identify at least one location (a first location), within the region of interest for further interrogation via SWIR. This first location may be selected based on one of size, shape, color, or other attribute (such as a likelihood of drug material being found in a certain location) associated with the first location or an object or person within the first location. For example, when assessing a region of interest for drug materials, the region of interest may comprise a car, and a first location comprising a door handle may be selected.

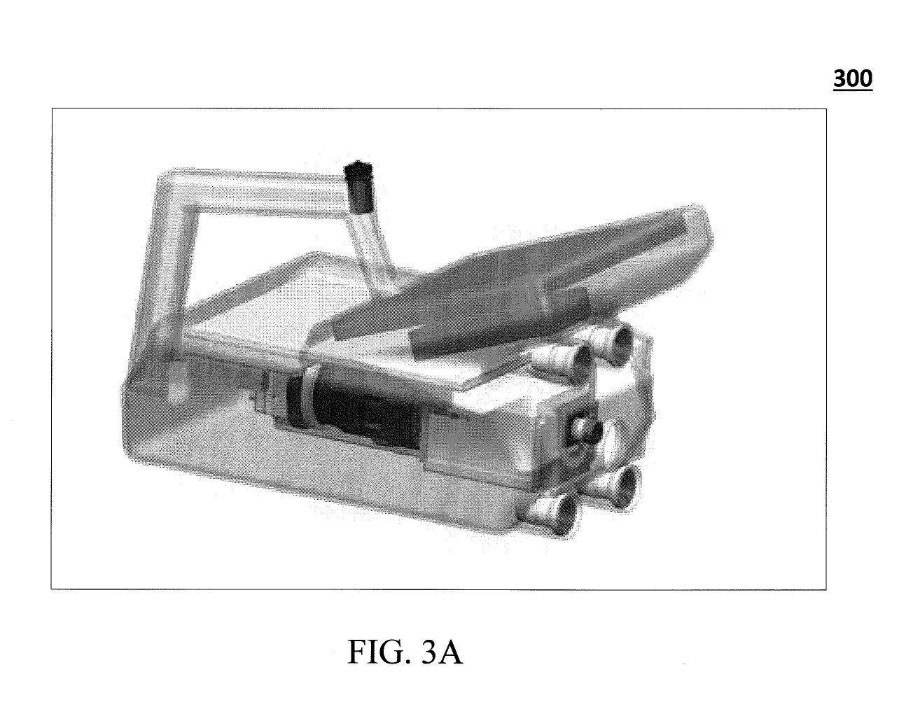

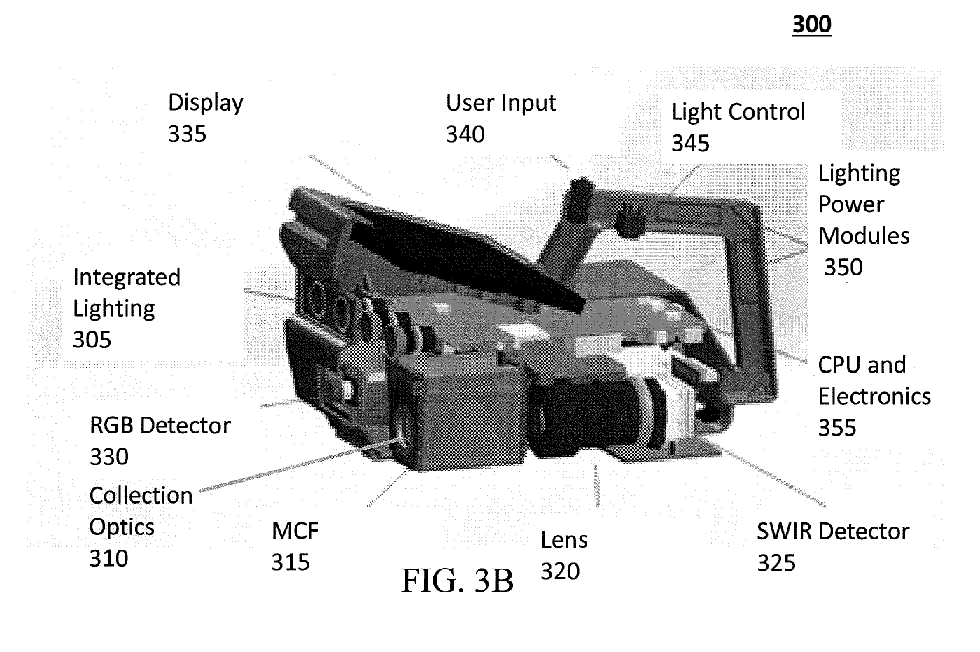

FIG. 3A is illustrative of an exemplary housing of a portable device of the present disclosure. FIG. 3B is illustrative of one embodiment of the portable device of FIG. 3A. In one embodiment, the portable device 300 may comprise at least one collection optics 310 configured to collect a plurality of interacted photons from a first location comprising an unknown material. A tunable filter 315 may be configured to filter the interacted photons collected by the collection optics 310 into a plurality of wavelength bands. In one embodiment, the tunable filter 315 may comprise at least one of: a Fabry Perot angle tuned filter, an acousto-optic tunable filter, a liquid crystal tunable filter, a Lyot filter, an Evans split element liquid crystal tunable filter, a Solc liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, a liquid crystal Fabry Perot tunable filter, and a multi-conjugate tunable filter (MCF), and combinations thereof.

In one embodiment, as illustrated by FIG. 3B, this tunable filter may comprise filter technology available from ChemImage Corporation, Pittsburgh, Pa. This technology is more fully described in the following U.S. patents and patent applications: U.S. Pat. No. 6,992,809, filed on Jan. 31, 2006, entitled “Multi-Conjugate Liquid Crystal Tunable Filter,” U.S. Pat. No. 7,362,489, filed on Apr. 22, 2008, entitled “Multi-Conjugate Liquid Crystal Tunable Filter,” Ser. No. 13/066,428, filed on Apr. 14, 2011, entitled “Short wave infrared multi-conjugate liquid crystal tunable filter.” These patents and patent applications are hereby incorporated by reference in their entireties.

A lens 320 may direct the filtered photons from the tunable filter 315 to a first detector, such as a SWIR detector 325. In one embodiment of the present disclosure, the portable device comprises a lens 320 suitable for use in a portable device. The use of a smaller lens (as opposed to a telescope lens that may be found in a larger system) allows for the system's small size. In one embodiment, the device may comprise a fixed focal length optic. The present disclosure also contemplates the use of a smaller camera format (in one embodiment a smaller sized 640×512 pixel camera). The present disclosure also contemplates the use of an embedded processor to reduce the size of the computer and increase speed.

In one embodiment, a lens 320 may further comprise a zoom optic capable of viewing a large area, or imaging a localized area at high magnification. In one embodiment of operation, an area would first be screened using the wide field setting on the zoom lens. Once the area is screened and potential targets are identified, confirmation of the area may be accomplished as necessary by using the narrow field setting on the zoom lens.

The SWIR detector 325 may be configured to generate at least one SWIR data set representative of the first location. In one embodiment, the SWIR detector 325 may comprise at least one of: a CCD detector, an intensified charged coupled device (ICCD) detector, a mercury cadmium telluride (MCT) detector, an indium antimonide (InSb) detector, and an InGaAs detector. The SWIR data set may comprise at least one of: a SWIR spectrum and a SWIR hyperspectral image.

In one embodiment, the portable device 300 may comprise integrated lighting 305 to enable operating the portable device using active illumination. This may be advantageous in low light conditions or where environmental factors may affect the amount of light in an outside scene. However, the present disclosure also contemplates the portable device 300 may be operated using passive illumination (such as solar radiation), and so the integrated lighting 305 may be optional. The integrated lighting 305 may be controlled by the light control 345 and be powered by a lighting control module 350.

In one embodiment, illustrated by FIG. 3B, the portable device 300 may further comprise at least one RGB detector 230 for generating at least one RGB image representative of a region of interest. It is contemplated that any number of collection optics 210 configurations may be used to enable the generation of the RGB image.

A display 335 may be provided to display at least one of the RGB image and the SWIR data set. The display 335 may also be used to display the result after the SWIR data set is analyzed. For example, a detection image showing areas of drug material in the first location may be displayed, with the drug material indicated by using pseudo colors to color an image. Other messages/alerts may also be configured for display to a user on the display 335.

At least one processor, such as a central processing unit 355 may be configured to analyze the SWIR data set and perform other functions needed to operate the portable device 300. The central processing unit 355 may store software, code, or algorithms that can be used to acquire and/or analyze data.

In one embodiment, the portable system 300 may further comprise one or more communication ports for user input 340. In one embodiment, the user input 340 may be used for electronically communicating with other electronic equipments such as a server or printer. In one embodiment, such communication may be used to communicate with a reference database or library comprising at least one of: a reference spectra corresponding to a known material and a reference short wave infrared spectroscopic image representative of a known material. In such an embodiment, the device may be configured for remote communication with a host station using a wireless link to report important findings or update its reference library.

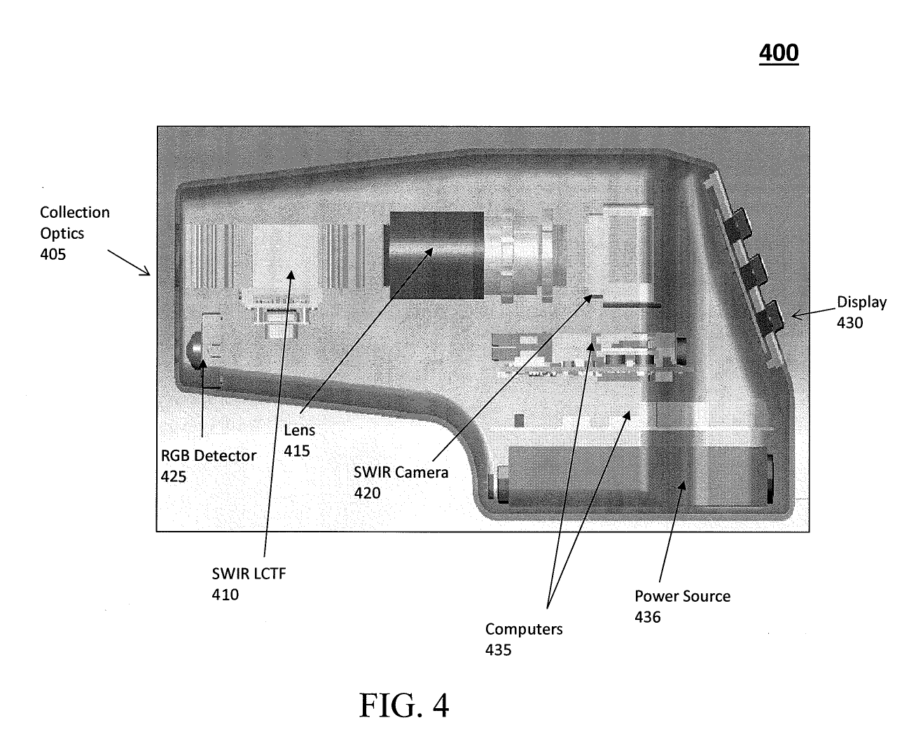

FIG. 4 illustrates another embodiment of a portable system of the present disclosure. In such an embodiment, the portable system 400 comprises at least one collection lens 405 to collect a plurality of interacted photons from at least one location comprising an unknown material. The collected photons may be filtered by a tunable filter 410 into a plurality of wavelength bands. In FIG. 4, the tunable filter 410 is illustrated as a LCTF, but as in the embodiment of FIG. 3B, the tunable filter 410 may comprise at least one of: a Fabry Perot angle tuned filter, an acousto-optic tunable filter, a liquid crystal tunable filter, a Lyot filter, an Evans split element liquid crystal tunable filter, a Solc liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, a liquid crystal Fabry Perot tunable filter, and a multi-conjugate tunable filter, and combinations thereof.

The filtered photons may be passed through a lens 415 and detected at a detector 420. The detector 420 may be configured to generate at least one SWIR data set. In one embodiment, the SWIR data set may comprise at least one of: a SWIR spectrum and a SWIR hyperspectral image. As in the embodiment in FIG. 3B, the SWIR detector may comprise at least one of: a CCD detector, a ICCD detector, a MCT detector, an InSb detector, and an InGaAs detector.

In one embodiment, the portable device 400 may further comprise at least one RGB detector, configured to generate at least one RGB image representative of a region of interest comprising the first location. This RGB image may be analyzed to select the first location for further interrogation via SWIR. A display 430 and processor 435 may also be provided in the portable system 400 and operate in a similar way to those in the embodiment of FIG. 3B. A power source 436, which may comprise at least one battery, may be provided to power the portable device 400.

In another embodiment, the present disclosure provides for a non-transitory data storage medium containing program code, which, when executed by a processor causes the processor to: collect a plurality of interacted photons from a first location wherein the foist location comprises at least one unknown material; filter the interacted photons into a plurality of wavelength bands; detect the filtered photons to generate at least one SWIR data set representative of the first location; and analyze the SWIR data set to associate the unknown material with at least one known material, wherein the known material comprises at least one drug.

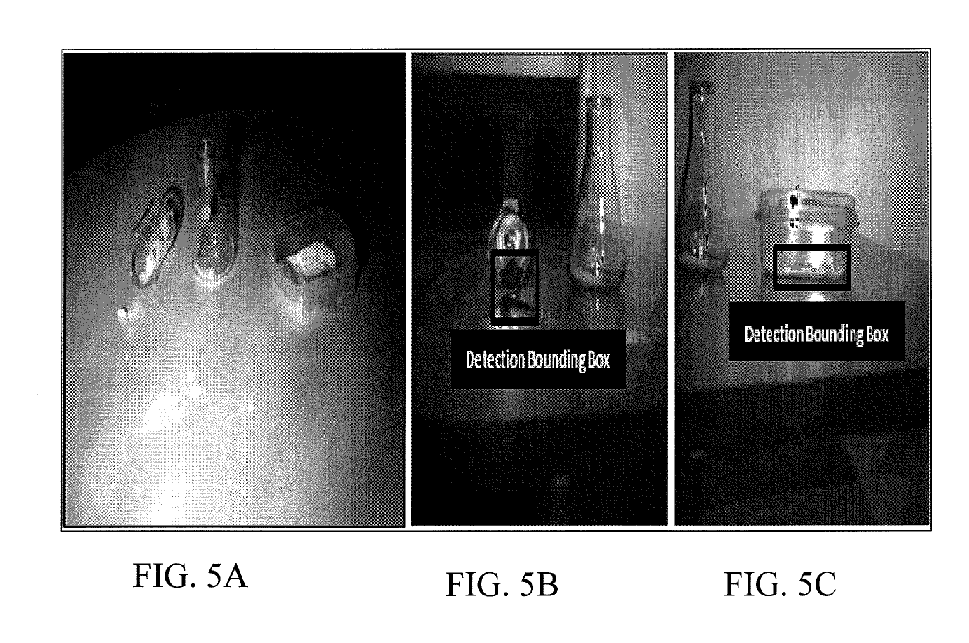

FIGS. 5A-5C are illustrative of the detection capabilities of a portable system of the present disclosure. The data in FIGS. 54-5C was generated using an Aperio™ portable sensor, available from Chemlmage Corporation, Pittsburgh, Pa., at a standoff range of two meters. FIG. 5A shows two simulants (Simulant 1 and Simulant 2) as a mixed residue. FIG. 5B illustrates the detection of Simulant 1 and FIG. 5C illustrates the detection of Simulant 2.

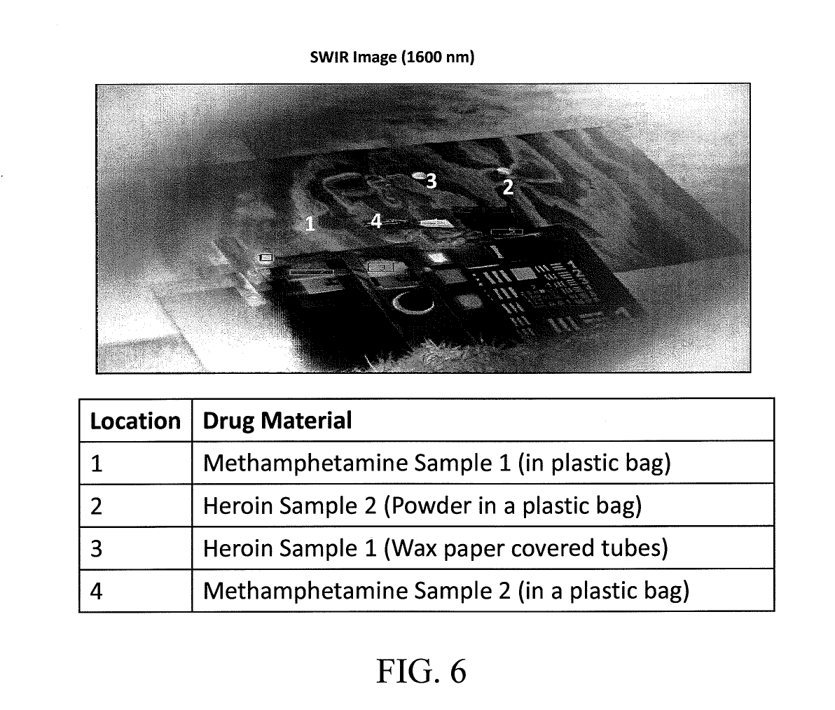

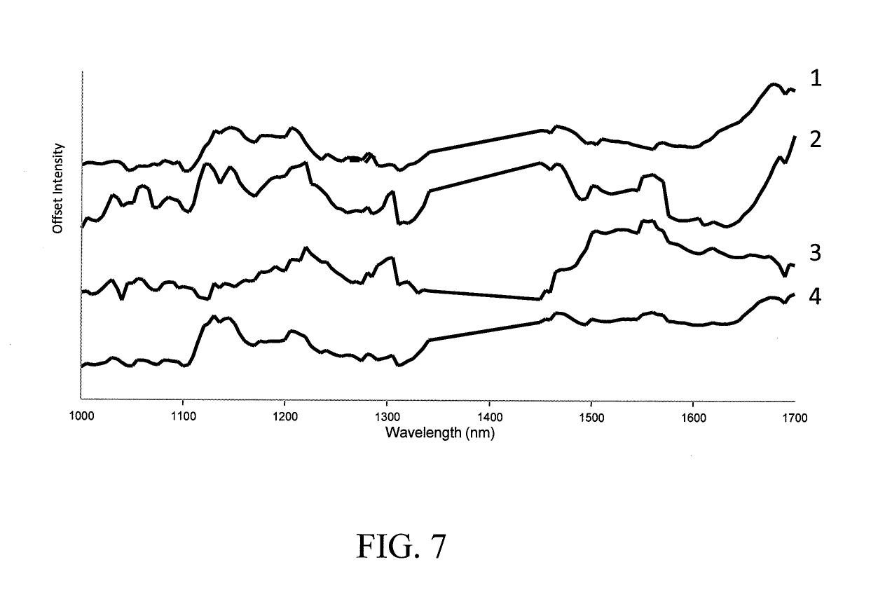

FIGS. 6-7 further illustrate the detection capabilities of a portable system and method of the present disclosure the data was generated using an Aperio™ portable sensor at a standoff distance. FIG. 6 illustrates a SWIR image with various drug materials deposited at various locations with in a sample scene. FIG. 7 illustrates the spectra associated with each location. As can be seen from the spectra, the drug materials may be detected and differentiated from each other using SWIR technology.

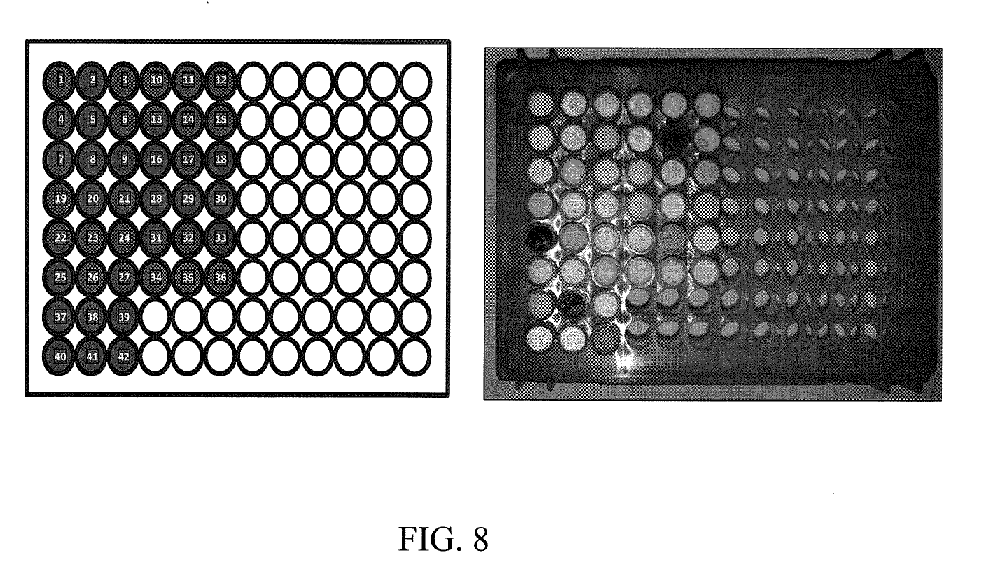

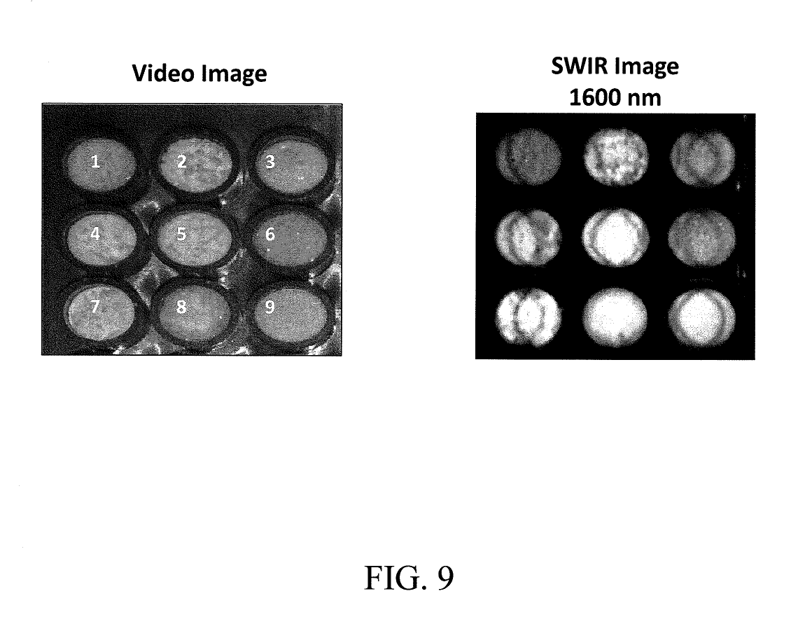

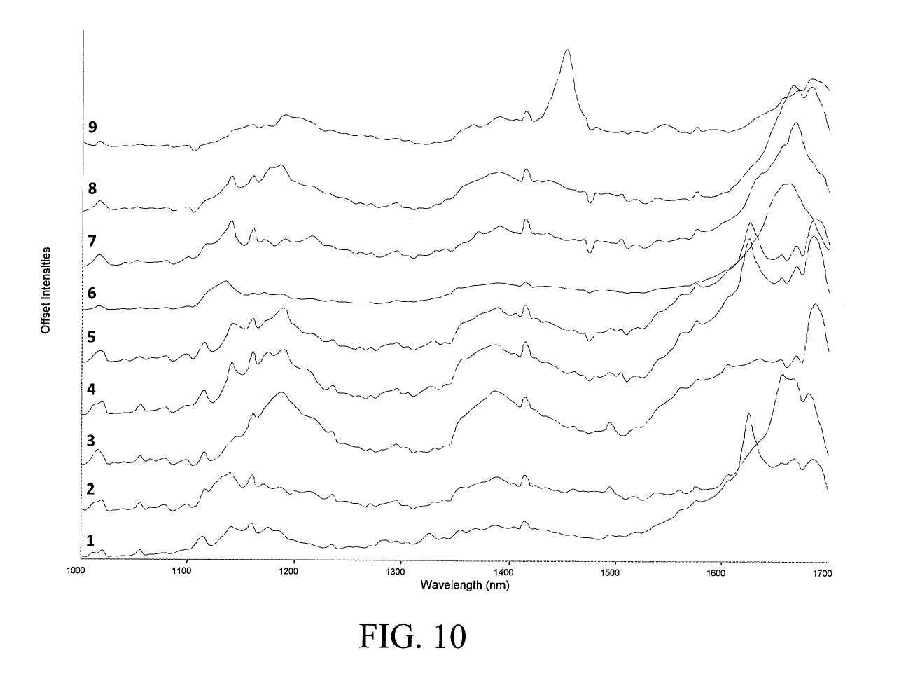

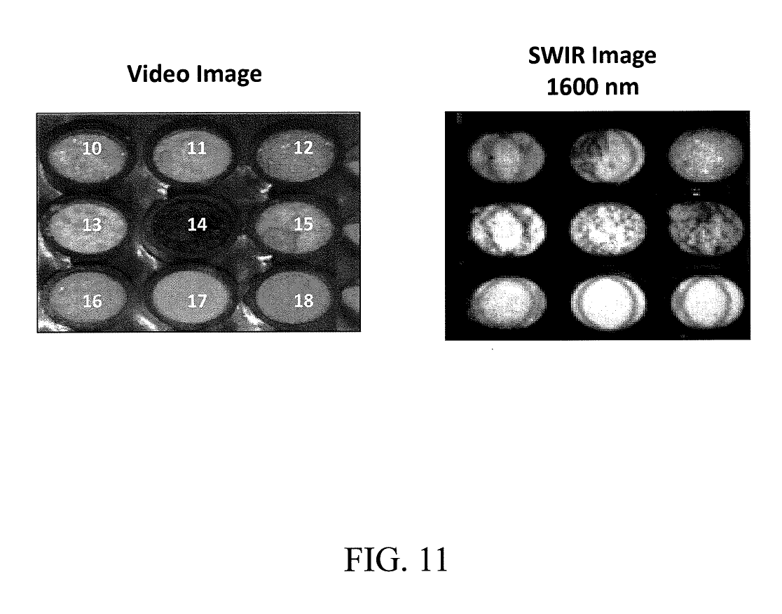

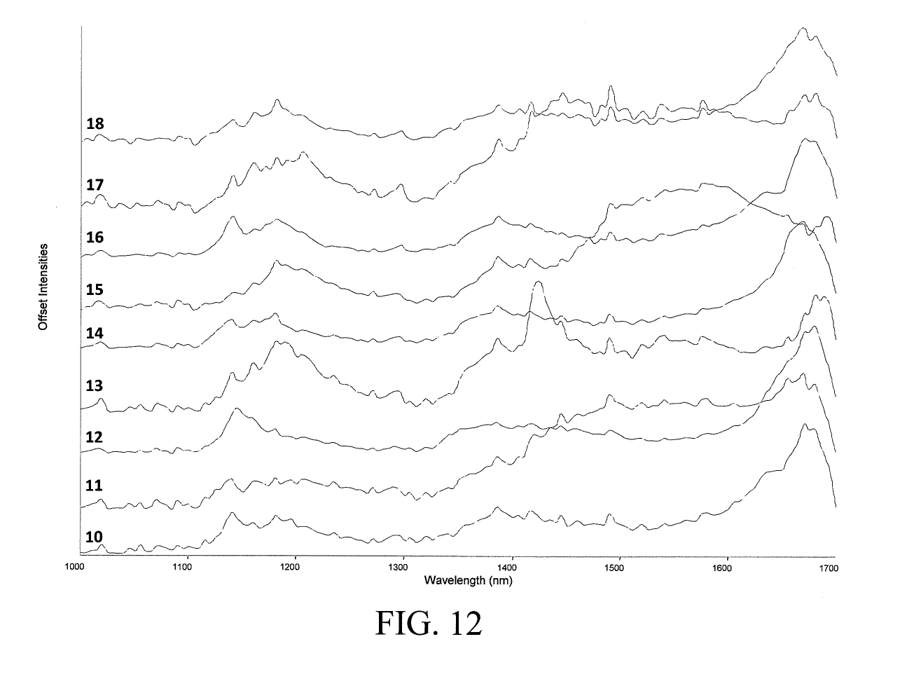

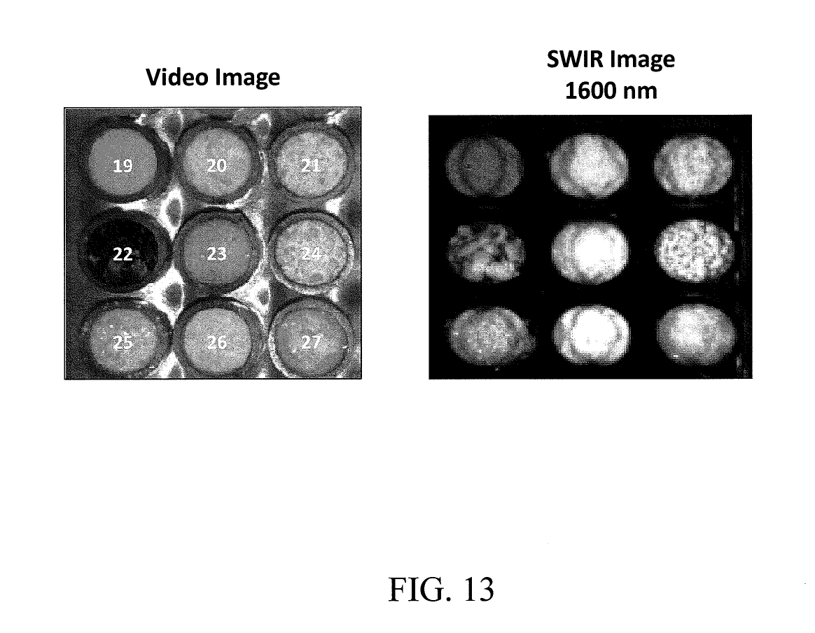

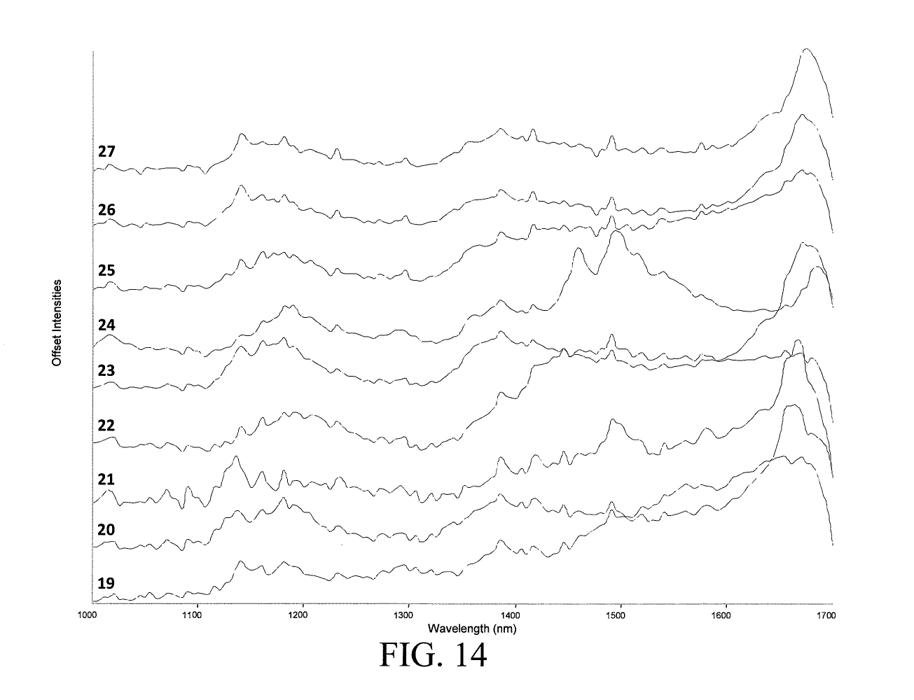

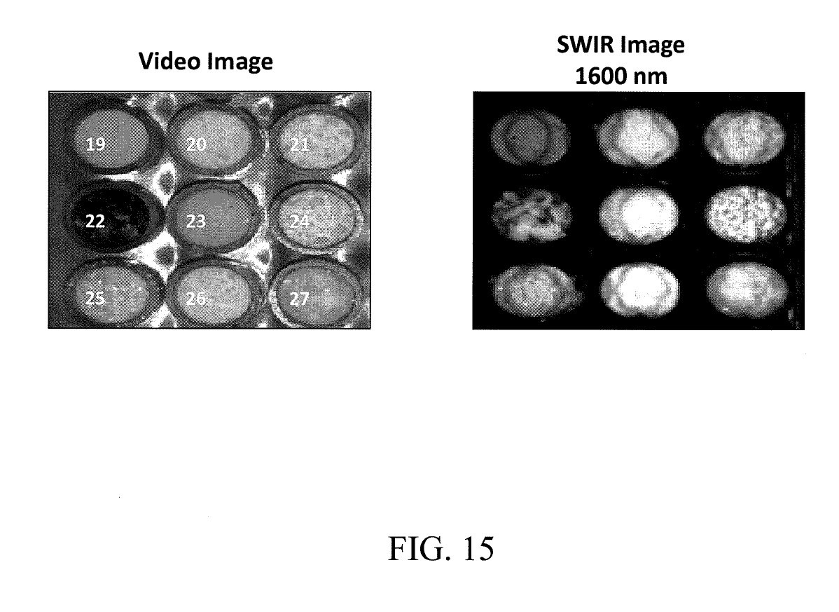

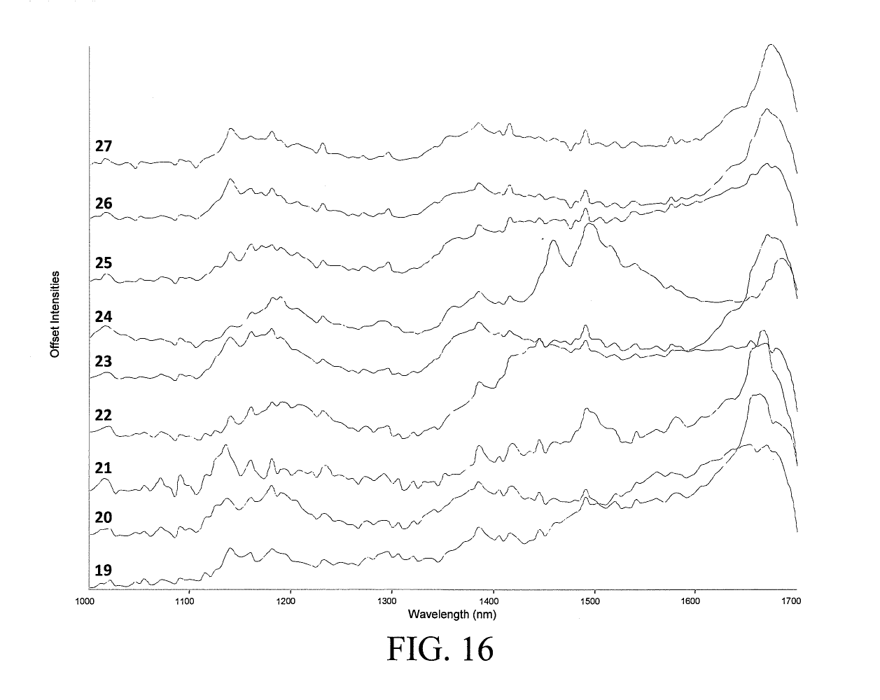

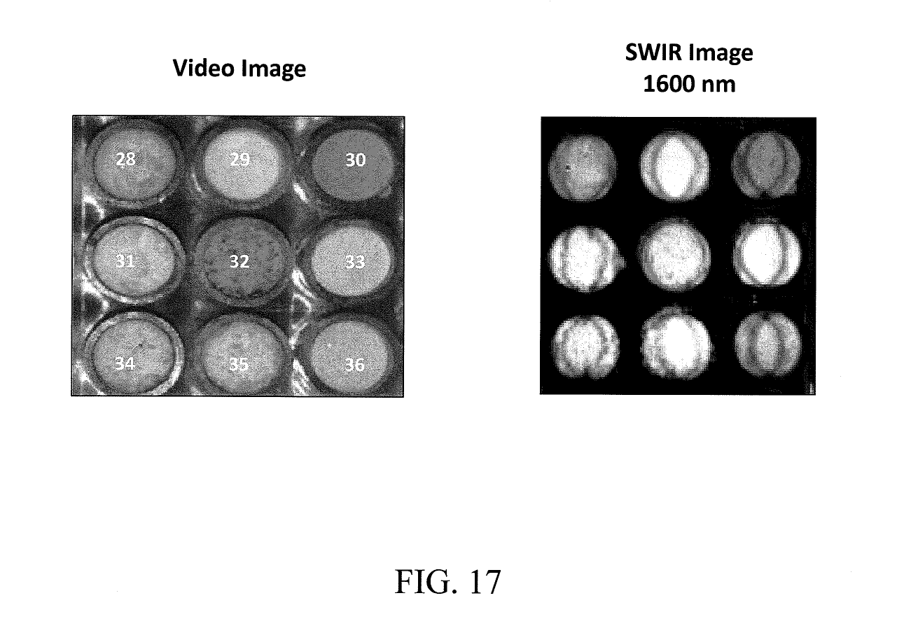

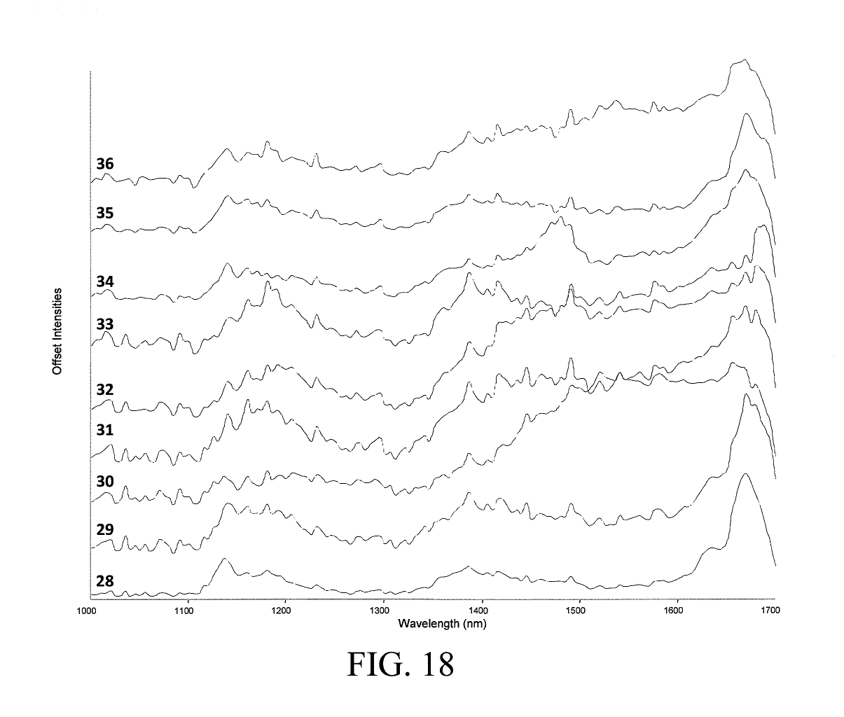

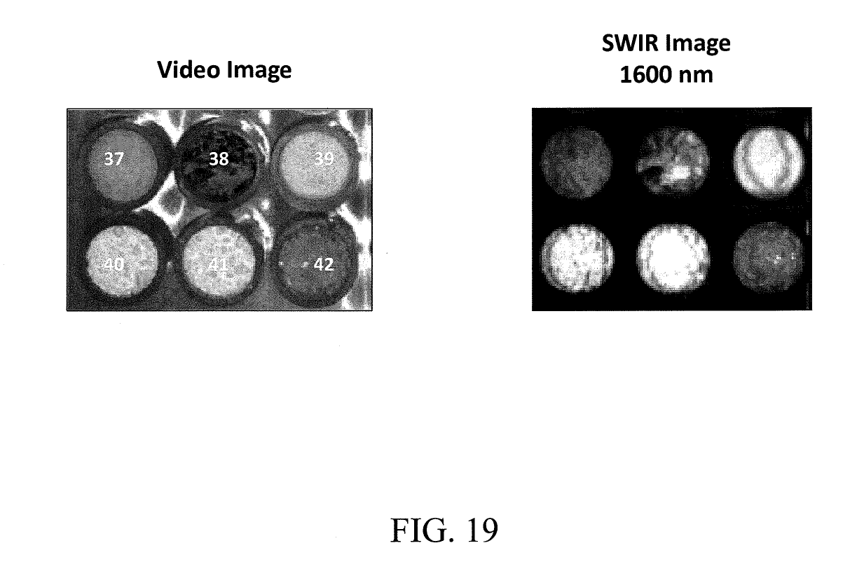

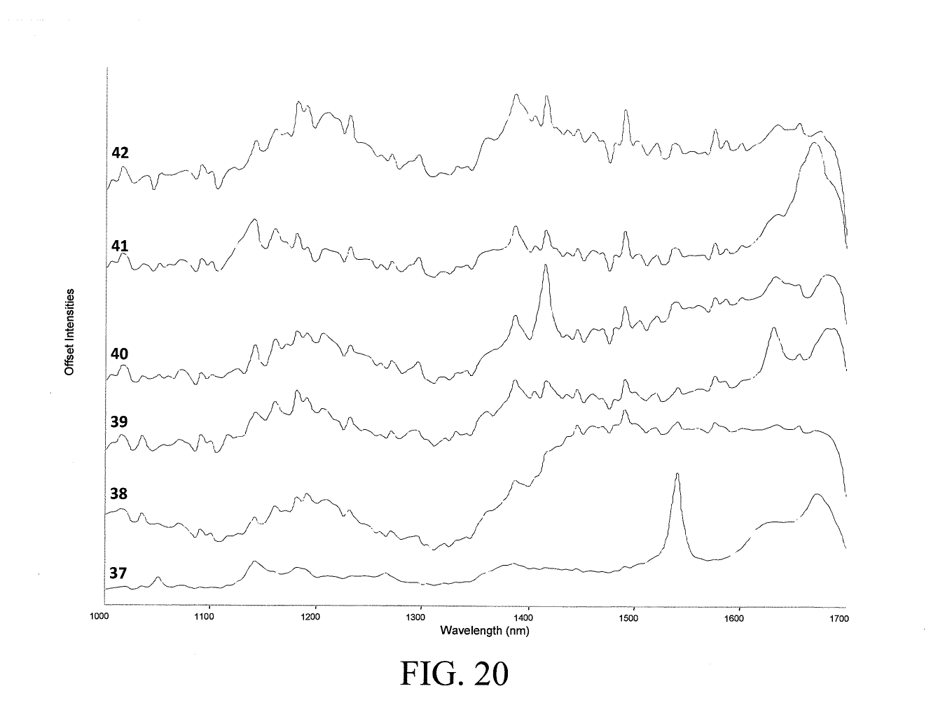

FIGS. 8-22 provide further support for the use of SWIR technology to detect drug materials. Various samples comprising drug materials were deposited at discrete locations in FIG. 8 for analysis using SWIR CONDOR™ technology, available from Chemlmage Corporation, Pittsburgh, Pa. Table 1 below illustrates the various drug samples and their corresponding locations in FIG. 8.

TABLE 1

| Location | Drug Material |
|---|---|
| 1 | Allobarbital |
| 2 | Alprazolam |
| 3 | Amobarbital |
| 4 | Aprobarbital |
| 5 | Butalbital |
| 6 | Chlordiazepoxide |
| 7 | Clonazepam |
| 8 | Cocaine (base) |
| 9 | Codeine |
| 10 | D-amphetamine sulfate |
| 11 | Diazepam |
| 12 | Diphenhydramine |
| 13 | Fluoxymesterone |
| 14 | Flurazepam di-HCl |
| 15 | Gamma-hydroxybutyric acid |
| 16 | Glutethimide |
| 17 | Hexobarbital |
| 18 | Hydromorphone HCl |
| 19 | Hydroxyamphetamine |
| 20 | Ketamine |
| 21 | Lorazepam |
| 22 | Marijuana |
| 23 | Meperidine HCl |
| 24 | Meprobamate |
| 25 | Mescaline |
| 26 | Methadone HCl |
| 27 | Methamphetamine HCl |
| 28 | Methaqualone |
| 29 | Methylphenidate HCl |
| 30 | Oxazepam |
| 31 | Oxycodone HCl |
| 32 | Pentazocine |
| 33 | Pentobarbital |
| 34 | Phendimetrazine bitartrate |
| 35 | Phenmetrazine HCl |
| 36 | Phenobarbital |
| 37 | Pseudoephedrine |
| 38 | Psilocyn |
| 39 | Secobarbital |
| 40 | Stanozolol |
| 41 | Triazolam |
| 42 | Blank (Silica Only) |

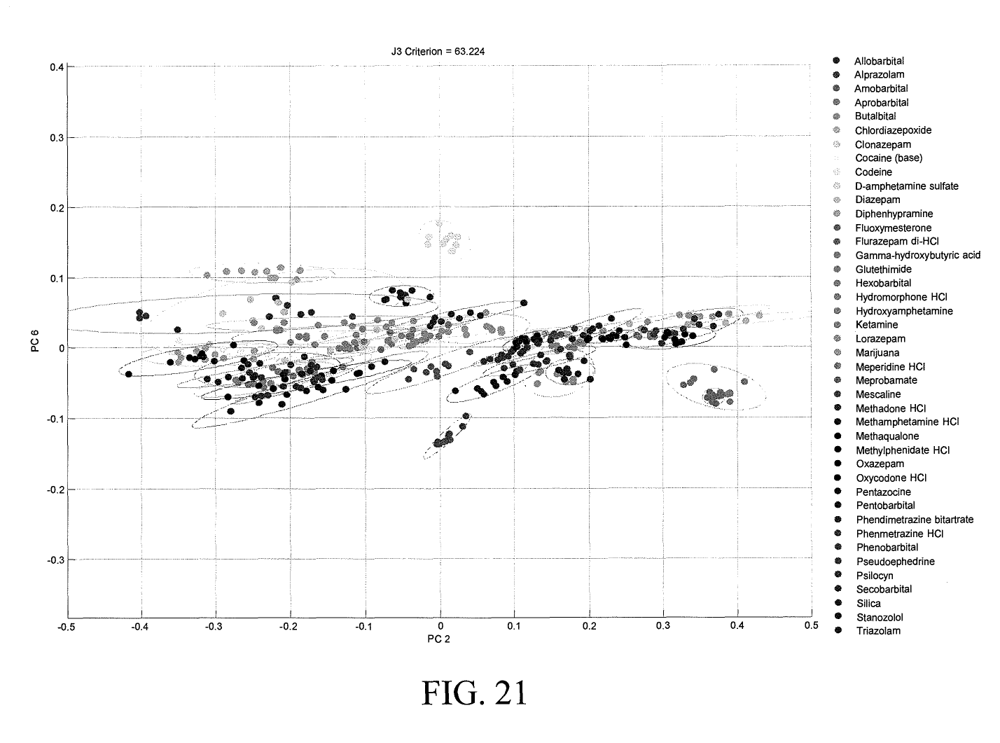

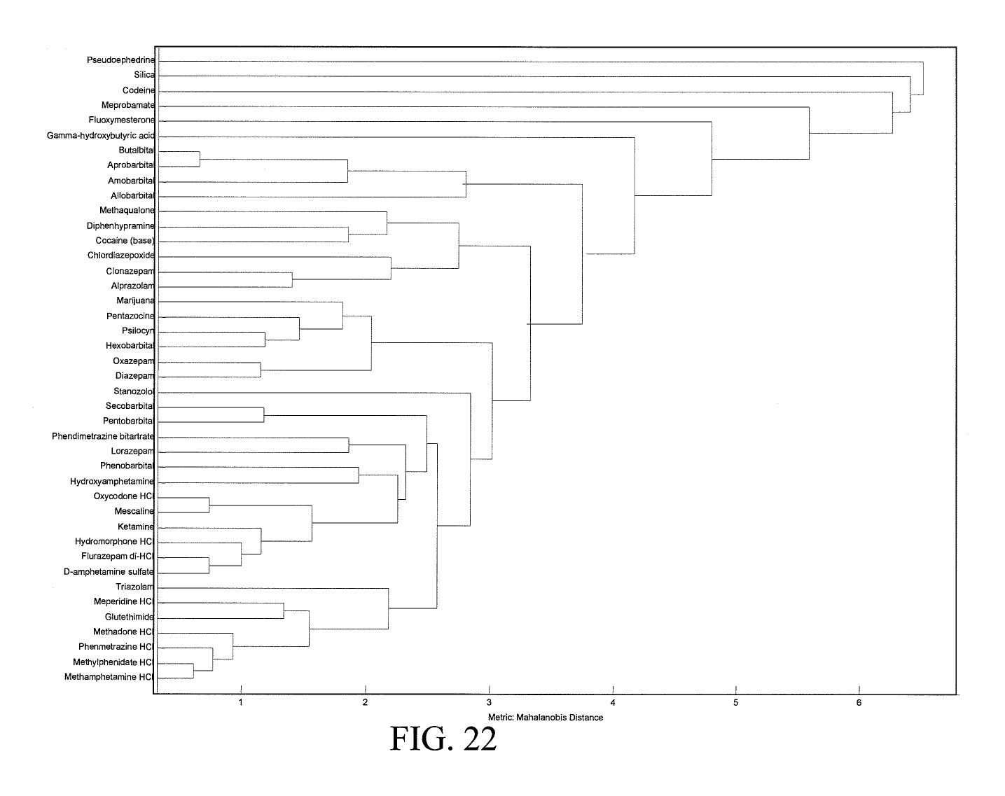

FIGS. 8-20 illustrate video images, SWIR images, and spectra associated with each material deposited in FIG. 8. A scatter plot showing the results of a method of the present disclosure applying PLSDA is illustrated in FIG. 21. As can be seen from FIG. 21, such a method holds potential for detecting and discriminating between drug materials. FIG. 22 is illustrative another embodiment of a method of the present disclosure applying a MD algorithm to the data. MD is a metric that displays a similarity of an unknown sample to a known sample. As illustrated in the dendogram, such an embodiment holds potential for detecting drug material. The method may also hold potential for differentiating between various drug materials in a scene. These results illustrate the potential for SWIR hyperspectral imaging and/or spectroscopy for detecting drug materials.

While the disclosure has been described in detail in reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method for detecting drug materials comprising:
collecting a plurality of interacted photon from a first location wherein the first location comprises at least one unknown material;
filtering the interacted photons into a plurality of wavelength bands;
detecting the filtered photons to generate at least one SWIR data set representative of the first location; and
analyzing the SWIR data set to associate the unknown material with at least one known material, wherein the known material comprises at least one drug.

2. The method of claim 1 wherein the SWIR data set further comprises at least one of: a SWIR spectrum and a SWIR hyperspectral image.

3. The method of claim 1 wherein the analyzing is further achieved by applying at least one algorithmic technique.

4. The method of claim 3 wherein applying the algorithmic technique further comprises comparing the SWIR data set with at least one reference data set, wherein each reference data set is associated with a known material.

5. The method of claim 3 wherein the algorithmic technique further comprises at least one chemometric technique.

6. The method of claim 3 wherein the algorithmic technique further comprises at least one ratiometric technique.

7. The method of claim 1 further comprising illuminating the first location to generate the plurality of interacted photons.

8. The method of claim 7 wherein the illuminating further comprises at least one of: active illumination and passive illumination.

9. The method of claim 7 wherein the illuminating comprises active illumination, further comprising illuminating the first location using the portable device.

10. The method of claim 1 wherein the interacted photons further comprise at least one of:
photons scattered by the first location, photons emitted by the first location, photons reflected by the first location, photons absorbed by the first location.

11. The method of claim 1 further comprising selecting the first location by analyzing an RGB image representative of a region of interest.

12. A system for detecting drug materials comprising:
at least one collection lens to collect a plurality of interacted photons from a first location, wherein the first location comprises at least one unknown material;
a tunable filter to filter the plurality of interacted photons into a plurality of wavelength bands;
a first detector configured to detect the filtered photons and generate at least one SWIR data set representative of the first location; and
at least one processor configured to analyze the SWIR data set to associated the unknown material with at least one known material, wherein the known material comprises at least one drug.

13. The system of claim 12 wherein the tunable filter further comprises at least one of: a multi-conjugate tunable filter, a liquid crystal tunable filter, acousto-optical tunable filters, Lyot liquid crystal tunable filter, Evans Split-Element liquid crystal tunable filter, Solc liquid crystal tunable filter, Ferroelectric liquid crystal tunable filter, Fabry Perot liquid crystal tunable filter, and combinations thereof.

14. The system of claim 12 wherein the first detector further comprises at least one of: a CCD detector, an ICCD detector, a MCT detector, an InSb detector, and an InGaAs detector.

15. The system of claim 12 wherein the processor is further configured to analyze the SWIR data set by applying at least one algorithmic technique.

16. The system of claim 15 wherein the processor is further configured to compare the SWIR data set to at least one reference data set by applying the algorithmic technique.

17. The system of claim 16 wherein the algorithmic technique further comprises at least one chemometric technique.

18. The system of claim 16 wherein the algorithm further comprises at least one ratiometric technique.

19. The system of claim 12 further comprising at least one RGB detector configured to generate at least one image representative of a region of interest.

20. The system of claim 19 wherein the processor is further configured to analyze the RGB image to identify a first location, wherein the first location comprises the unknown material.

21. The system of claim 12 wherein the SWIR data set further comprises at least one of: a SWIR spectrum and a SWIR hyperspectral image.

22. The system of claim 12 further comprising at least one illumination source configured to illuminate the first location to generate the plurality of interacted photons.

23. The system of claim 12 further comprising at least one display configured to display the result of analyzing the SWIR data set.

24. A non-transitory data storage medium containing program code, which, when executed by a processor causes said processor to:
collect a plurality of interacted photons from a first location wherein the first location comprises at least one unknown material;
filter the interacted photons into a plurality of wavelength bands;
detect the filtered photons to generate at least one SWIR data set representative of the first location; and
analyze the SWIR data set to associate the unknown material with at least one known material, wherein the known material comprises at least one drug.

25. The non-transitory data storage medium of claim 24 which, when executed by a processor further causes the processor to compare the SWIR data set to at least one reference data set, wherein each reference data set is associated with at least one known material.

26. The non-transitory data storage medium of claim 24 which, when executed by a processor further causes said processor to achieve the comparison by applying at least one algorithmic technique.
